(19) United States
(12) Patent Application Publication
(10) Pub. No.: US 2015/0065142 A1
(43) Pub. Date: Mar. 5, 2015

(54) METHOD AND APPARATUS FOR PERFORMING HANDOVER IN VEHICLE COMMUNICATION ENVIRONMENT

(71) Applicant: Electronics and Telecommunications Research Institute, Daejeon (KR)

(72) Inventor: Yoo-Seung SONG, Daejeon (KR)

(73) Assignee: Electronics and Telecommunications Research Institute, Daejeon (KR)

(21) Appl. No.: 14/193,763

(22) Filed: Feb. 28, 2014

(30) Foreign Application Priority Data
Aug. 27, 2013 (KR) 10-2013-0101929

(51) Int. Cl. H04W 36/00

(52) U.S. Cl. CPC H04W 36/0094
USPC 455/437; 455/561

(57) ABSTRACT

In a vehicle communication environment, a handover apparatus that is located at a random vehicle determines whether to perform handover based on a received signal intensity value of a signal that is received from base stations that are installed at the roadside and information that is acquired from peripheral vehicles. In this case, it is determined whether to perform handover using a signal intensity value and a link base station value representing a base station to which each vehicle is connected among information that is acquired from peripheral vehicles.

### CROSS-REFERENCE TO RELATED APPLICATION

This application claims priority to and the benefit of Korean Patent Application No. 10-2013-0101929 filed in the Korean Intellectual Property Office on Aug. 27, 2013, the entire contents of which are incorporated herein by reference.

### BACKGROUND OF THE INVENTION

(a) Field of the Invention

The present invention relates to handover. More particularly, the present invention relates to a method and apparatus for performing handover in a vehicle communication environment in which a communication link is formed between a vehicle and a base station.

(b) Description of the Related Art

Nowadays, various wireless communication technologies for providing a service such as infotainment within a moving vehicle are being researched. Particularly, wireless access in vehicular environment (WAVE) communication technology that can provide a wireless communication service even at a speed of maximum 200 km/h has been developed. In WAVE technology, a physical layer L1 has been modified to constantly perform communication even in a high speed environment, and in order to provide a safety service of a vehicle in real time, a protocol having minimum latency is used. In WAVE technology, a bandwidth of a channel is about 10 MHz, and when using a 64 quadrature amplitude modulation (QAM) modulation method, data can be transmitted at a maximum of 27 Mbps.

Because a base station that is installed at a roadside generally has coverage of about 1 km, in a vehicle moving at a speed of 100 km/h in an express highway, handover in which a link to another base station is newly connected approximately every 36 seconds occurs. In such a vehicle communication environment, as WAVE technology is made to transmit a safety service of a vehicle in real time, an important issue becomes embodying minimum latency and minimum handover delay in WAVE technology. Therefore, various methods of generating minimum delay in a handover-occurring environment between base stations are suggested.

In general, a method that is suggested to minimize handover delay is a method of determining handover with a value of a received signal strength indicator (RSSI) of a signal that is received through a WAVE service announcement (WSA) that a vehicle receives from a base station. This method is a one of newly connecting a link to a corresponding base station when a signal of a greater size than that of an RSSI value of a present base station is input. Because a value of received RSSI sharply changes, a vehicle calculates a signal change via a low pass filter (LPF) and determines handover based on the calculated signal change. However, in such a method, as a ping-pong phenomenon occurs according to a design parameter of an LPF, it is difficult to design an optimal LPF, and handover delay occurs according to the ping-pong phenomenon and thus there is a problem that it is difficult to grasp optimal handover timing.

### SUMMARY OF THE INVENTION

The present invention has been made in an effort to provide a method and apparatus for performing handover having advantages of being capable of estimating an optimal handover time point in a vehicle communication environment.

An exemplary embodiment of the present invention provides a handover apparatus in a vehicle communication network in which communication between roadside base stations and a vehicle is performed, the handover apparatus including: a transmitting and receiving unit that receives a signal that is broadcasted from a base station and that receives a hello message that is transmitted from the vehicles; and a signal processor that acquires a received signal intensity value of a signal that is received from the base station, that acquires vehicle information from the hello message, and that determines whether to perform handover based on the acquired received signal intensity value and the vehicle information, wherein the vehicle information includes a link base station value representing a base station to which the vehicle is linked.

The signal processor may include: a received signal intensity processor that acquires an average of received signal strength indication (RSSI) values based on received signal intensity values of a signal that is received from the base stations; a peripheral vehicle information processor that acquires vehicle information of a peripheral vehicle from the hello message, wherein the vehicle information includes the link base station value and a vehicle location; an information fusion processor that multiplies and fuses a ratio of the link base station value that is input from the traveling vehicle information processor and an average RSSI value that is provided from the received signal intensity processor; and a handover processor that determines whether to perform handover based on the link base station value and the fused average RSSI value.

The peripheral vehicle information processor may provide a link base station value of a peripheral vehicle that is located within a predetermined distance from a vehicle at which the handover apparatus is located to the information fusion processor based on the vehicle information.

The information fusion processor may include: a ratio calculating unit that calculates a weight value on each base station basis based on a ratio of a vehicle that is linked to each base station that is acquired according to the link base station values of the peripheral vehicle; a multiplier that multiplies the weight value by an average RSSI value that is provided from the information fusion processor and that outputs a comparison value; and a comparing unit that compares the comparison values.

The handover processor may include a determining and processing unit that determines to perform handover, if a difference between a maximum comparison value having a maximum value among the comparison values and a comparison value corresponding to a signal that is received from a base station in which a vehicle at which a handover apparatus is presently located is linked is equal to or larger than a preset offset value.

The hello message may include a first field representing a message type, a second field including time to live (TTL) representing a period in which a message frame is effective, a third field representing a length of a message frame, a fourth field representing channel information including transmitting power of a message frame, a fifth field including status information of a vehicle, and a sixth field representing information about a base station to which a corresponding vehicle is linked.

Another embodiment of the present invention provides a method of performing handover of a vehicle in a vehicle communication network in which communication between roadside base stations and the vehicle is performed, the method including: receiving a signal that is broadcasted from a base station and acquiring a receive signal intensity value of the received signal; receiving a hello message that is transmitted from the vehicles and acquiring vehicle information from the hello message, wherein the vehicle information includes a link base station value representing a base station to which the vehicle is linked; and determining whether to perform handover based on the acquired received signal intensity value and a link base station value that is included in the vehicle information.

The determining of whether to perform handover may include: calculating a weight value on each base station basis based on a ratio of a vehicle that is linked to each base station according to the link base station values; multiplying a calculated weight value of each base station by the received signal intensity values and acquiring comparison values; and determining whether to perform handover based on the comparison values.

The determining of whether to perform handover based on the comparison values may include determining to perform handover if a difference between a maximum comparison value having a maximum value among the comparison values and a comparison value corresponding to a signal that is received from a base station in which a vehicle at which a handover apparatus is presently located is linked is equal to or larger than a preset offset value.

The method may further include selecting vehicle information corresponding to a peripheral vehicle that is located within a predetermined distance from a vehicle at which the handover apparatus is located among the acquired vehicle information, after the acquiring of vehicle information.

The determining of whether to perform handover may include determining whether to perform handover using an average of received signal strength indication (RSSI) values of received signal intensity values corresponding to a link base station value that is included in the selected vehicle information among received signal intensity values that are acquired in the acquiring of a receive signal intensity value.

### BRIEF DESCRIPTION OF THE DRAWINGS

FIG. 1 is a diagram illustrating a network environment in which handover is performed according to an exemplary embodiment of the present invention.

FIG. 2 is a diagram illustrating a structure of a handover apparatus according to an exemplary embodiment of the present invention.

FIG. 3 is a diagram illustrating a structure of a signal processor of a handover apparatus according to an exemplary embodiment of the present invention.

FIG. 4 is a diagram illustrating a structure of an information fusion processor and a handover processor according to an exemplary embodiment of the present invention.

FIG. 5 is a flowchart illustrating a method of performing handover according to an exemplary embodiment of the present invention.

FIG. 6 is a diagram illustrating a structure of a hello message according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention.

Accordingly, the drawings and description are to be regarded as illustrative in nature and not restrictive. Like reference numerals designate like elements throughout the specification.

In the entire specification and claims, unless explicitly described to the contrary, the word “comprise” and variations such as “comprises” or “comprising” will be understood to imply the inclusion of stated elements but not the exclusion of any other elements.

A mobile station (MS) may indicate a terminal, a mobile terminal (MT), a subscriber station (SS), a portable subscriber station (PSS), user equipment (UE), and an access terminal (AT), and may include an entire function or a partial function of the MT, the SS, the PSS, the UE, and the AT.

Further, a base station (BS) may indicate a node B, an access point (AP), a radio access station (RAS), a base transceiver station (BTS), and a mobile multihop relay (MMR)-BS, and may include an entire function or a partial function of the AP, the RAS, the node B, the BTS, and the MMR-BS.

Hereinafter, a method and apparatus for performing handover in a vehicle communication environment according to an exemplary embodiment of the present invention will be described.

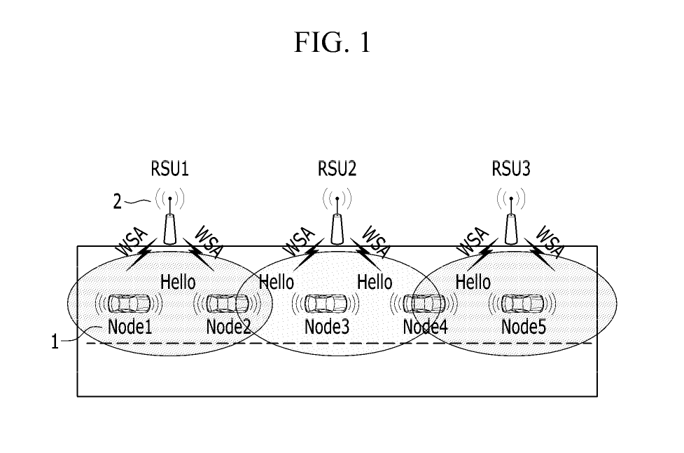

FIG. 1 is a diagram illustrating a network environment in which handover is performed according to an exemplary embodiment of the present invention.

As shown in FIG. 1, a terminal 1 that is located at a vehicle is connected to an infrastructure to transmit and receive a signal to and from a base station 2 (may be referred to as a road side unit (RSU)) that transmits a signal by wireless. In such a vehicle communication environment (vehicle-to-vehicle (V2V) and vehicle-to-infrastructure (V2I) communication environments) in which communication is performed using a terminal, each vehicle (or a terminal that is located at a vehicle) may be referred to as a node.

The base station 2 transmits various data by wireless, and part of wireless transmission data is a WAVE service announcement (WSA) message. The terminal 1 of the vehicle receives base station information and channel information that may use a service through a WSA message that is periodically transmitted from the base station 2. That is, the terminal 1 measures intensity of a signal that is periodically transmitted from the base station 2 like a WSA message, grasps a proximity level of a peripheral base station, and acquires primary information that may determine a base station to perform handover.

Further, for communication between vehicles, the terminal 1 of the vehicle periodically transmits a hello message. The terminal 1 acquires information about a vehicle existing at a periphery of a located vehicle, and various information such as a location or a speed of vehicles through a hello message that is transmitted from each vehicle. In an exemplary embodiment of the present invention, a hello message that is used for communication between vehicles includes information regarding a base station with which each vehicle presently communicates. Specifically, a terminal 1 of each vehicle generates and transmits the hello message including information about a base station to which a communication link is presently connected, and acquires information about a base station to which a link of a peripheral vehicle is presently connected as well as intensity of a radio wave that is received through the hello message that is received from each vehicle. In this way, in a vehicle communication environment according to an exemplary embodiment of the present invention, terminals of each vehicle share information about a base station that presently forms a link and use the shared information upon determining handover.

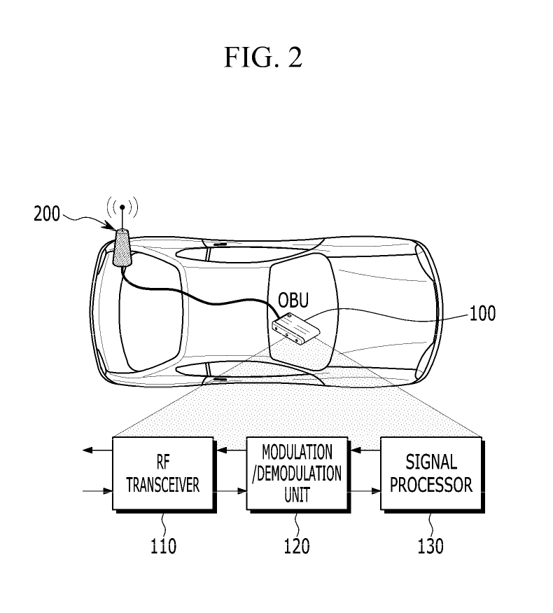

FIG. 2 is a diagram illustrating a structure of a handover apparatus according to an exemplary embodiment of the present invention.

A handover apparatus 100 according to an exemplary embodiment of the present invention is a radio wave transmitting/receiving apparatus (may be embodied in an on board unit (OBU) form) for transmitting/receiving a wireless signal between a base station and a vehicle and is connected to an antenna 200. The antenna 200 may be connected by wire to the handover apparatus 100.

The antenna 200 that is mounted in the vehicle may be an omni-directional antenna having no specific directionality, but the antenna 200 is not limited thereto.

The handover apparatus 100 includes an RF transceiver 110 for transmitting/receiving a signal through the antenna 200, a modulation/demodulation unit (may be referred to as a modem) 120 that modulates/demodulates a signal, and a signal processor 130 (may be referred to as a central processing unit (CPU)).

The RF transceiver 110 transmits/receives a signal through the antenna 200, and amplifies or modulates an analog signal. The modulation/demodulation unit 120 modulates a signal that is input from the RF transceiver 110 to a digital signal, and transfers the digital signal to the signal processor 130.

The RF transceiver 110 modulates a frequency signal of a baseband to a carrier frequency that is used upon transmitting by wireless and transmits it, and enables transmitting power of the transmitted signal to satisfy a requested condition.

The modulation/demodulation unit 120 converts an analog signal to a digital signal and transfers an error-free message to the signal processor 130 of a superordinate layer by restoring a damaged signal. Further, information necessary for handover that is acquired from the received message is transferred together with the message to the signal processor 130.

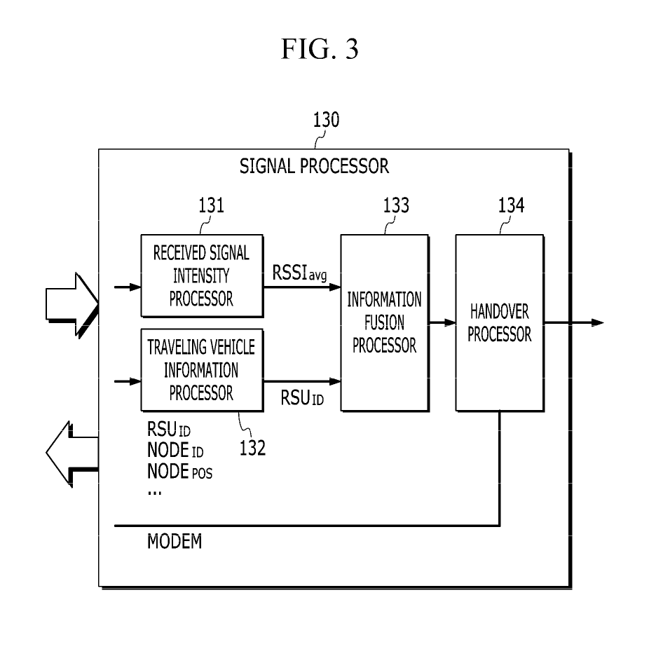

FIG. 3 is a diagram illustrating a structure of a signal processor of a handover apparatus according to an exemplary embodiment of the present invention.

The signal processor 130 includes a received signal intensity processor 131, a traveling vehicle information processor 132, an information fusion processor 133, and a handover processor 134.

The received signal intensity processor 131 acquires signal intensity of a signal that is received from a base station based on a signal that is transferred from the modulation/demodulation unit 120. Because a signal that is input to the received signal intensity processor 131 is generally a high frequency signal, the received signal intensity processor 131 acquires an average of a received signal strength indication (RSSIavg) signal from an input signal using a low pass filter (LPF) and transfers the RSSIavg signal to the information fusion processor 133. Because the vehicle can receive a broadcasting signal such as WSA from a plurality of base stations, an RSSI value corresponding to the received broadcasting signal of the base station may be separately managed.

The traveling vehicle information processor 132 acquires information of a peripheral vehicle from a signal, particularly, a signal corresponding to the hello message that is transferred from the modulation/demodulation unit 120. The information of the peripheral vehicle includes information regarding the base station that is linked to each vehicle, node ID, and node location (coordinates). The traveling vehicle information processor 132 separately classifies information about a vehicle at a periphery within a predetermined distance of a present vehicle (here, the present vehicle is a vehicle in which a handover apparatus is installed) based on peripheral vehicle information. The traveling vehicle information processor 132 provides a link base station value (e.g., a RSU_ID value) representing a base station to which the classified peripheral vehicles are presently linked to the information fusion processor 133.

The information fusion processor 133 matches information that is provided from the received signal intensity processor 131 and the traveling vehicle information processor 132. That is, the information fusion processor 133 fuses a ratio value of at least one RSSIavg that is input from the received signal intensity processor 131 and an RSU_ID value that is received from vehicles adjacent to a present vehicle that is input from the traveling vehicle information processor 132. The fused values are provided to the handover processor 134. The information fusion processor 133 may be referred to as a channel/vehicle status information fusion processor.

A first design parameter of a reference of vehicles that provides a base station value RSU_ID to the information fusion processor 133 and a second design parameter representing whether to provide some superordinate RSSI among average RSSIs that are received from many base stations to the information fusion processor 133 may be used, and such first and second design parameters may be adaptively adjusted according to an actual system to which the handover apparatus 100 according to an exemplary embodiment of the present invention is applied. For example, in order to provide only information (link base station value RSU_ID) corresponding to vehicles that are located within a predetermined distance (or radius) from a present vehicle among vehicles that transmit a hello message to the information fusion processor 133, a first design parameter of a distance (or a radius) may be set. Further, in order to provide only a base station average RSSI of the superordinate setting number having the best value among average RSSI values of base stations to the information fusion processor 133, a second design parameter may be set.

The handover processor 134 determines a base station to which a present vehicle is to finally perform handover based on data that is provided from the information fusion processor 133.

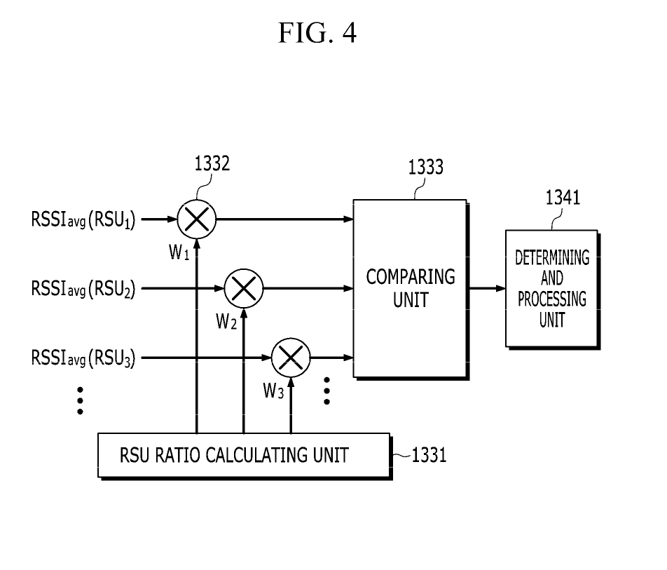

FIG. 4 is a diagram illustrating a structure of an information fusion processor and a handover processor according to an exemplary embodiment of the present invention.

The information fusion processor 133 includes an RSU ratio calculating unit 1331, a plurality of multipliers (representative number 1332 is given), and a comparing unit 1333. The handover processor 134 includes a determining and processing unit 1341.

The RSU ratio calculating unit 1331 calculates weight values W1, W2, W3, . . . on a base station basis. The RSU ratio calculating unit 1331 classifies link base station values (RSU_ID values) representing a base station to which peripheral vehicles are presently linked, and calculates a weight value based on a ratio of each RSU_ID value. For example, in peripheral vehicles within a predetermined radius, W1 indicates a ratio of a vehicle that is linked to RSU1, W2 indicates a ratio of a vehicle that is linked to RSU2, and W3 indicates a ratio of a vehicle that is linked to RSU3.

The multiplier 1332 multiplies a ratio that is calculated for an RSU_ID value on each base station basis by an RSSlavg of a corresponding base station, and outputs the value to the comparing unit 1333. A weight value that is given on a base station basis is multiplied by average RSSI values corresponding to a signal that is received from base stations to which peripheral vehicles are linked through the multiplier 1332. In other words, a weight value is changed according to the number of vehicles that are linked to a corresponding base station.

The comparing unit 1333 compares values of which a weight value Wi on a base station basis is multiplied by an RSSIavg corresponding to the number of base station broadcasting signals that a present vehicle receives, and determines which signal that is received from which base station is largest among the values. Here, i is an index value of the base station.

The determining and processing unit 1341 of the handover processor 134 determines a base station to perform handover, and performs handover. The determining and processing unit 1341 determines whether to perform handover based on values that are output from the comparing unit 1333, or sets two superordinate values of values that are output from the comparing unit 1333 as candidate values, and determines to perform handover if a difference value between the two candidate values is equal to or larger than a preset value.

Hereinafter, a method of performing handover in a vehicle communication environment according to an exemplary embodiment of the present invention based on such a structure will be described.

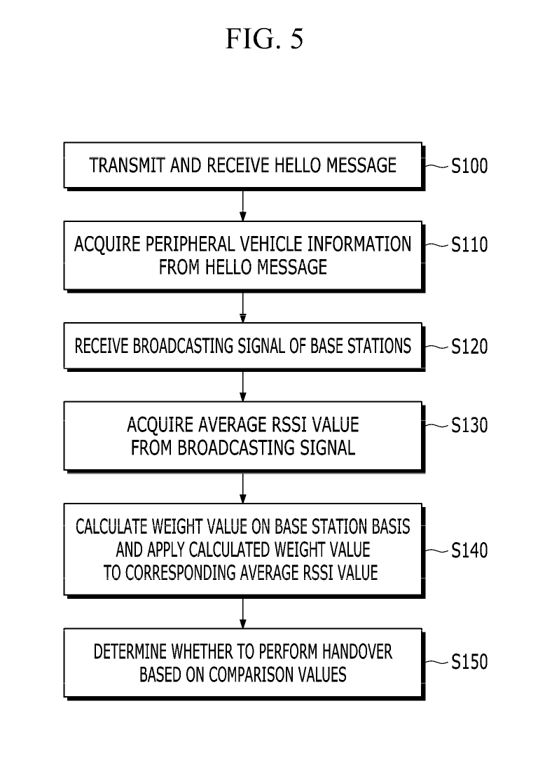

FIG. 5 is a flowchart illustrating a method of performing handover according to an exemplary embodiment of the present invention.

As shown in FIG. 1, at the roadside, a plurality of base stations RSU 1, RSU2, RSU3, . . . are installed, vehicles node1, node2, node3, node4, node5, . . . travel, and in a vehicle communication environment in which each vehicle performs communication through a corresponding terminal, the handover apparatus 100 that is located at a random vehicle transmits a hello message and receives a hello message that is transmitted from each vehicle (S100), as shown in FIG. 5.

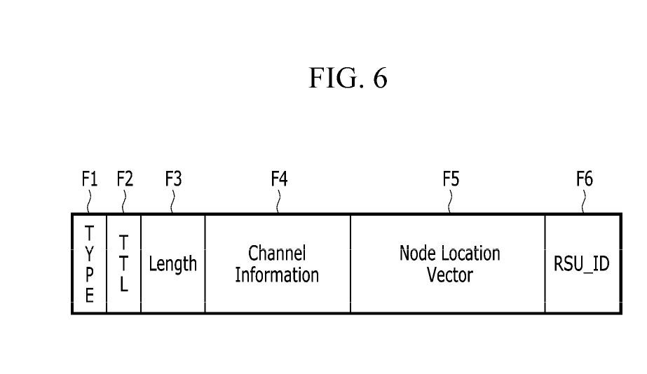

The hello message according to an exemplary embodiment of the present invention includes information representing a base station to which a corresponding vehicle is presently linked, and may have a structure of FIG. 6.

FIG. 6 is a diagram illustrating a structure of a hello message according to an exemplary embodiment of the present invention.

The hello message is a message that is transmitted to notify information of each vehicle for communication between vehicles and vehicle multihop communication. The hello message according to an exemplary embodiment of the present invention includes status information (location, speed, and direction) of a corresponding vehicle, and information notifying a base station to which a communication link of the corresponding vehicle is connected.

For this purpose, specifically, as shown in FIG. 6, the hello message includes a first field F1 representing a message type, a second field F2 including time to live (TTL) representing an effective period of a corresponding message frame, a third field F3 representing a length of a corresponding message frame, a fourth field F4 representing channel information including transmitting power of a corresponding message frame, a fifth field F5 including status information of a vehicle, and a sixth field F6 representing information RSU_ID about a base station to which a corresponding vehicle is linked.

As vehicles at a single hop distance share information about a base station to which peripheral vehicles are presently connected through such a hello message, when determining handover of a corresponding vehicle, important information is obtained.

The fifth field F5 including status information of the vehicle includes information such as a latitude, a longitude, a speed, a direction, and accuracy of a corresponding vehicle. The hello message that is formed in such a structure may be repeatedly transmitted according to a predetermined cycle. When the transmitting cycle of a hello message is short, information is acquired in real time, but in consideration of an increase in overhead, a transmitting cycle may be optimally set.

As shown in FIG. 5, the handover apparatus 100 processes the received hello message and acquires information of a vehicle that is included in each hello message. Particularly, the handover apparatus 100 only acquires information (a link base station value representing a base station to which the vehicle is linked, etc.) corresponding to a peripheral vehicle that is located within a predetermined distance based on a location that is included in information of the vehicle, and uses the information for later processing (S110).

Further, the handover apparatus 100 receives a signal that is transmitted from each base station that is installed at the roadside (S120), processes the received signal, and acquires an average RSSI value corresponding to signal intensity of each base station (S130). In this case, the handover apparatus 100 may acquire only average RSSI values of signals having a value of predetermined intensity or more among received signals of base stations, and use the average RSSI values for later processing.

The handover apparatus 100 calculates a weight value on a base station basis based on a ratio of link base station values (RSU_ID values) (a ratio of a vehicle that is linked to each base station) representing a base station to which peripheral vehicles are presently linked. The handover apparatus 100 applies a weight value on each base station basis to an average RSSI value on a base station basis and thus acquires comparison values on a base station basis for determining handover (S140).

The handover apparatus 100 determines whether to perform handover based on comparison values that are acquired on a base station basis. For example, the handover apparatus 100 selects two comparison values of comparison values (e.g., a maximum comparison value having a maximum value of comparison values and a comparison value corresponding to a signal that is received from a base station to which a vehicle is presently linked, or a comparison value of a maximum value and a comparison value having a second maximum value), and determines to perform handover if a difference value of the selected comparison values is equal to or larger than a preset offset value (S150).

Here, after handover is determined, as an example, the handover apparatus 100 may perform handover that connects a link to a base station having a comparison value of a maximum value.

According to an exemplary embodiment of the present invention, in a vehicle communication environment, a terminal that is located at a traveling vehicle can process handover occurring when communicating with several base stations that are installed at the roadside, and particularly, a vehicle can determine an optimal handover time point based on a signal that is received from a base station that is installed at the roadside. Therefore, by minimizing handover delay, handover accuracy can be improved, and a handover ping-pong problem that has conventionally occurred can be solved.

An exemplary embodiment of the present invention may not only be embodied through the above-described apparatus and/or method, but may also be embodied through a program that executes a function corresponding to a configuration of the exemplary embodiment of the present invention or through a recording medium on which the program is recorded, and can be easily embodied by a person of ordinary skill in the art from a description of the foregoing exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A handover apparatus in a vehicle communication network in which communication between roadside base stations and a vehicle is performed, the handover apparatus comprising:
a transmitting and receiving unit that receives a signal that is broadcasted from a base station and that receives a hello message that is transmitted from the vehicles; and
a signal processor that acquires a received signal intensity value of a signal that is received from the base station, that acquires vehicle information from the hello message, and that determines whether to perform handover based on the acquired received signal intensity value and the vehicle information, wherein the vehicle information comprises a link base station value representing a base station to which the vehicle is linked.

2. The handover apparatus of claim 1, wherein the signal processor comprises:
a received signal intensity processor that acquires an average of received signal strength indication (RSSI) values based on received signal intensity values of a signal that is received from the base stations;
a peripheral vehicle information processor that acquires vehicle information of a peripheral vehicle from the hello message, wherein the vehicle information comprises the link base station value and a vehicle location;
an information fusion processor that multiplies and fuses a ratio of the link base station value that is input from the traveling vehicle information processor and an average RSSI value that is provided from the received signal intensity processor; and
a handover processor that determines whether to perform handover based on the link base station value and the fused average RSSI value.

3. The handover apparatus of claim 2, wherein the peripheral vehicle information processor provides a link base station value of a peripheral vehicle that is located within a predetermined distance from a vehicle at which the handover apparatus is located to the information fusion processor based on the vehicle information.

4. The handover apparatus of claim 2, wherein the information fusion processor comprises:
a ratio calculating unit that calculates a weight value on each base station basis based on a ratio of a vehicle that is linked to each base station that is acquired according to the link base station values of the peripheral vehicle;
a multiplier that multiplies the weight value by an average RSSI value that is provided from the information fusion processor and that outputs a comparison value; and
a comparing unit that compares the comparison values.

5. The handover apparatus of claim 4, wherein the handover processor comprises a determining and processing unit that determines to perform handover, if a difference between a maximum comparison value having a maximum value among the comparison values and a comparison value corresponding to a signal that is received from a base station in which a vehicle at which a handover apparatus is presently located is linked is equal to or larger than a preset offset value.

6. The handover apparatus of claim 1, wherein the hello message comprises a first field representing a message type, a second field comprising time to live (TTL) representing a period in which a message frame is effective, a third field representing a length of a message frame, a fourth field representing channel information comprising transmitting power of a message frame, a fifth field comprising status information of a vehicle, and a sixth field representing information about a base station to which a corresponding vehicle is linked.

7. A method of performing handover of a vehicle in a vehicle communication network in which communication between roadside base stations and the vehicle is performed, the method comprising:
receiving a signal that is broadcasted from a base station and acquiring a receive signal intensity value of the received signal;
receiving a hello message that is transmitted from the vehicles and acquiring vehicle information from the hello message, wherein the vehicle information comprises a link base station value representing a base station to which the vehicle is linked; and
determining whether to perform handover based on the acquired received signal intensity value and a link base station value that is included in the vehicle information.

8. The method of claim 7, wherein the determining of whether to perform handover comprises:
calculating a weight value on each base station basis based on a ratio of a vehicle that is linked to each base station according to the link base station values;
multiplying a calculated weight value of each base station by the received signal intensity values and acquiring comparison values; and
determining whether to perform handover based on the comparison values.

9. The method of claim 8, wherein the determining of whether to perform handover based on the comparison values comprises determining to perform handover if a difference between a maximum comparison value having a maximum value among the comparison values and a comparison value corresponding to a signal that is received from a base station in which a vehicle at which a handover apparatus is presently located is linked is equal to or larger than a preset offset value.

10. The method of claim 7, further comprising selecting vehicle information corresponding to a peripheral vehicle that is located within a predetermined distance from a vehicle at which the handover apparatus is located among the acquired vehicle information, after the acquiring of vehicle information.

11. The method of claim 10, wherein the determining of whether to perform handover comprises determining whether to perform handover using an average of received signal strength indication (RSSI) values of received signal intensity values corresponding to a link base station value that is included in the selected vehicle information among received signal intensity values that are acquired in the acquiring of a receive signal intensity value.

12. The method of claim 7, wherein the signal that is broadcasted from the base station is a wave service announcement (WSA) signal.
